(19) United States
(12) Patent Application Publication
(10) Pub. No.: US 2025/0324165 A1
(43) Pub. Date: Oct. 16, 2025

(54) DESIGN SYSTEM AND DESIGN METHOD

(71) Applicant: Renesas Electronics Corporation, Tokyo (JP)

(72) Inventors: Takashi KUSACHI, Tokyo (JP); Mitsuhiro KIMURA, Tokyo (JP); Daigo TOKIOKA, Tokyo (JP)

(21) Appl. No.: 19/082,371

(22) Filed: Mar. 18, 2025

(30) Foreign Application Priority Data
Apr. 15, 2024 (JP) 2024-065715

(51) Int. Cl. H04N 23/80

(52) U.S. Cl. CPC H04N 23/80

(57) ABSTRACT

A design system is provided for enhancing the utilization rate of hardware accelerators during the execution of a video pipeline. The design system disclosed herein is for designing a video pipeline, which, based on a pipeline graph, job information related to multiple jobs included in the pipeline graph, hardware accelerator information related to multiple hardware accelerators included in the pipeline graph, and optimization conditions, creates a list of candidate combinations of the assignment of multiple jobs to multiple hardware accelerators, the execution order of multiple jobs, and the execution timing of each of the multiple jobs. It comprises an optimization unit that creates the list of candidate combinations and a result output unit that outputs the list of candidate combinations created by the optimization unit to the user.

### CROSS-REFERENCE TO RELATED APPLICATIONS

The disclosure of Japanese Patent Application No. 2024-065715 filed on Apr. 15, 2024, including the specification, drawings and abstract is incorporated herein by reference in its entirety.

### BACKGROUND

The present invention relates to a design system, a design/execution system, a design method, and a design/execution method.

Image processing functions using multiple hardware accelerators (HWA) have been put into practical use. To realize such image processing functions, a mechanism to design and execute combinations and execution sequences of hardware accelerators is required. This mechanism is called a video pipeline.

There are disclosed techniques listed below. [Non-patent Document 1] Thomas Kampmeyer, “Cyclic Scheduling Problems”, 2006

As such a mechanism, for example, Non-patent Document 1 discloses techniques and methods for solving optimization problems to determine the optimal execution order and timing of processes based on objective functions such as time, when executing many tasks repeatedly under various constraints.

### SUMMARY

The method of Non-patent Document 1 uses a graph structure, where multiple nodes each representing a job are connected by edges in execution order, as input data. The execution order of each node depends on their precedence relationships (e.g., a relationship where one job cannot be executed until another job is completed). Optimization parameters include, in addition to precedence relationships, the type and number of resources (hardware accelerators) executing each job, and the processing time of each job (also referred to as job execution time). The method of Non-patent Document 1 allows for determining the execution order and timing of each job based on these parameters, thereby obtaining a job execution schedule.

When applying the method of Non-patent Document 1 to a video pipeline, jobs are assigned to each hardware accelerator, and the start timing of those jobs is also determined. In this case, although it is possible to optimize (minimize) processing time using multiple hardware accelerators, each hardware accelerator experiences waiting time from the execution of one job to the start of the next job. In other words, there was a problem of reduced utilization (operating rate) of the entire set of hardware accelerators.

Thus, a state of low utilization, i.e., a state where each hardware accelerator has significant waiting time, leads to the issue of hardware accelerators not being utilized despite having the capacity to run other applications.

Other problems and novel features will become apparent from the description of this specification and the accompanying drawings.

According to one embodiment, the design system according to this disclosure is a design system for designing a video pipeline. This design system includes, a pipeline graph, job information regarding multiple jobs included in the pipeline graph, hardware accelerator information regarding multiple hardware accelerators included in the pipeline graph, and an optimization unit that creates a list of candidate combinations of the assignment of the multiple jobs to the multiple hardware accelerators, the execution order of the multiple jobs, and the execution timing of each of the multiple jobs based on optimization conditions, and a result output unit that outputs the list of candidate combinations created by the optimization unit to the user. To be equipped with.

According to one embodiment, the design/execution system according to this disclosure is a design/execution system for designing and executing a video pipeline. This design/execution system includes, a pipeline graph, job information regarding multiple jobs included in the pipeline graph, hardware accelerator information regarding multiple hardware accelerators included in the pipeline graph, and an optimization unit that creates a list of candidate combinations of the assignment of the multiple jobs to the multiple hardware accelerators, the execution order of the multiple jobs, and the execution timing of each of the multiple jobs based on optimization conditions, and selects one combination from the list of candidate combinations based on a priority table, a result output unit that outputs the one combination selected by the optimization unit to the outside, and a pipeline execution unit that executes the video pipeline based on the one combination output from the result output unit. To be equipped with.

According to one embodiment, the design method according to this disclosure is a design method for designing a video pipeline. In this design method, a pipeline graph is received, and based on the pipeline graph, job information regarding multiple jobs included in the pipeline graph, hardware accelerator information regarding multiple hardware accelerators included in the pipeline graph, and optimization conditions, a list of candidate combinations of the assignment of the multiple jobs to the multiple hardware accelerators, the execution order of the multiple jobs, and the execution timing of each of the multiple jobs is created, and the created list of candidate combinations is output to the user.

According to one embodiment, the design/execution method according to this disclosure is a design/execution method for designing and executing a video pipeline. In this design/execution method, a pipeline graph is received, a list of candidate combinations of the assignment of the multiple jobs to the multiple hardware accelerators, the execution order of the multiple jobs, and the execution timing of each of the multiple jobs is created based on the pipeline graph, job information regarding multiple jobs included in the pipeline graph, hardware accelerator information regarding multiple hardware accelerators included in the pipeline graph, and optimization conditions, and one combination is selected from the list of candidate combinations based on a priority table, the selected one combination is output to the outside, and the video pipeline is executed based on the output one combination.

According to this disclosure, it is possible to provide a design system, a design/execution system, a design method, a design/execution method, and a program that can increase the utilization rate of hardware accelerators during the execution of a video pipeline.

### BRIEF DESCRIPTION OF THE DRAWINGS

FIG. 1 is a block diagram of a design system according to a first embodiment of this disclosure.

FIG. 2 is a diagram illustrating an example of a pipeline graph generated by the graph editor unit shown in FIG. 1.

FIGS. 3A and 3B are diagrams illustrating an example of hardware accelerator assignments where frame drops occur.

FIGS. 4A and 4B are diagrams illustrating an example of changes in delay due to the hardware accelerator assignment method.

FIG. 5 is a flowchart illustrating an example of optimization processing executed by the design system shown in FIG. 1.

FIG. 6 is a diagram illustrating an example of parameters input to the optimization unit shown in FIG. 1.

FIG. 7 is a diagram illustrating an example of a list of candidates that satisfy constraint condition C1.

FIG. 8 is a diagram indicating whether the list shown in FIG. 7 satisfies constraint condition C2.

FIG. 9 is a diagram illustrating information output from the optimization unit shown in FIG. 1.

FIG. 10 is a block diagram of a design/execution system according to a second embodiment of this disclosure.

FIG. 11 is a diagram illustrating an example of a priority table.

FIG. 12 is a table illustrating an example of setting a priority table and vehicle conditions in an in-vehicle application.

FIG. 13 is a flowchart illustrating an example of optimization processing executed by the design system shown in FIG. 10.

FIG. 14 is a diagram illustrating state transitions in the pipeline execution unit shown in FIG. 10.

### DETAILED DESCRIPTION

The embodiments will be described below with reference to the drawings. It should be noted that the drawings are simplified, and the technical scope of the embodiments should not be narrowly interpreted based on these drawings. Also, the same or similar elements are denoted by the same reference numerals, and redundant descriptions are omitted.

In the following embodiments, for convenience, explanations may be divided into multiple sections or embodiments when necessary. However, unless specifically stated otherwise, they are not unrelated to each other, but rather one is related to the other as a modification, application, detailed description, or supplementary explanation, etc. Furthermore, in the following embodiments, when referring to the number of elements, etc. (including the number, numerical values, quantities, ranges, etc.), unless specifically indicated or clearly limited to a specific number in principle, it is not limited to that specific number and may be more or less than the specific number.

Moreover, in the following embodiments, the components (including operational steps, etc.) are not necessarily essential unless specifically indicated or considered to be obviously essential in principle. Similarly, in the following embodiments, when referring to the shapes, positional relationships, etc. of components, unless specifically indicated or considered to be obviously not so in principle, it is assumed to include those that are substantially approximate or similar to those shapes, etc. The same applies to the above-mentioned numbers and the like, including the number, numerical value, amount, range, and the like.

### (Consideration of Issues in the Present Disclosure)

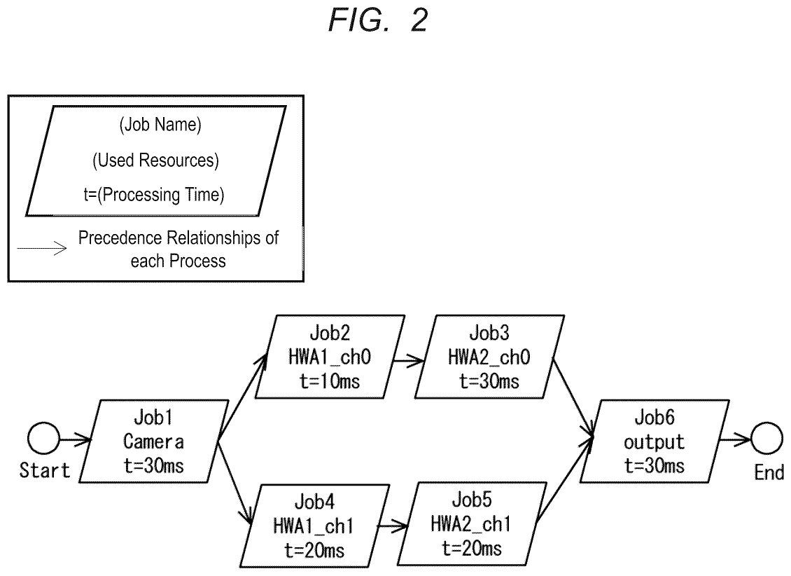

Before explaining the embodiments of the design system and design/execution system of the present disclosure, the issues assumed by the present disclosure will be briefly explained. Here, if necessary, refer to FIG. 2 described in the first embodiment below.

The design system and design/execution system of the present disclosure relate to the design and execution of a pipeline graph for a video pipeline as shown in FIG. 2 and are systems for processing image data captured by imaging devices such as in-vehicle cameras of vehicles like automobiles, which require some image processing.

Here, a pipeline graph is a graph that shows what constraints (e.g., precedence relationships) each of multiple jobs (Job) is subject to and in what order they are executed. A precedence relationship indicates a relationship where a certain job must be completed before executing another job. For example, in the example of FIG. 2, it shows that as a precedence relationship, Job2 must be completed before Job3 can be executed.

In conventional optimization of such a video pipeline, it was usually assumed to use the technology of non-patent document 1 to perform processing (minimization of execution time) that reduces the total execution time of multiple jobs. In this case, each job indicates processing executed on one of the hardware accelerators, and the precedence relationship can be regarded as the relationship between the output side and the input side of the image data being processed in the video pipeline.

In such conventional optimization, depending on the job allocation method, waiting times occur for each hardware accelerator, and optimization considering the reduction of this waiting time cannot be performed. That is, there was a problem of low utilization of hardware accelerators during video pipeline execution.

Particularly, when the utilization rate of hardware accelerators in an in-vehicle SoC (System on a Chip) running many applications is low, that is, when there is a lot of waiting time for the hardware accelerators, a problem arises where the hardware accelerators cannot be effectively utilized despite having the capacity to run other applications.

The inventors of the present disclosure considered an optimization method that allows changes to the hardware accelerators to be used for each job in order to maximize the performance of the hardware accelerators. The inventors of the present disclosure have arrived at a method where, without the user specifying the hardware accelerator channel for each job, an algorithm determines the optimal channel allocation, execution order, and execution timing of multiple jobs, thereby increasing the overall utilization rate of the hardware accelerators and allowing unused hardware accelerators to be allocated to other applications.

### First Embodiment

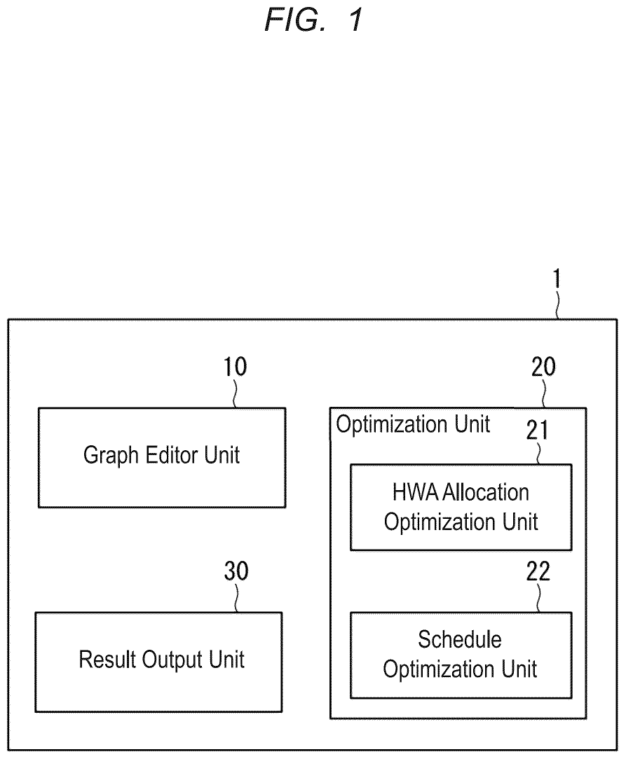

Below, with reference to FIGS. 1 to 9, the design system according to a first embodiment of the present disclosure will be described. The design system of this embodiment creates a pipeline graph based on conditions set by the user, and particularly optimizes the allocation of hardware accelerators. In the present disclosure, the design system will be described in detail for the case of creating a pipeline graph used for image processing of an in-vehicle camera (hereinafter sometimes abbreviated as camera).

Also, this design system outputs to the user a list of candidate allocations of hardware accelerators in order of the fewest number of hardware accelerators to which one or more jobs are assigned. Here, this list of candidate allocations is a list of candidates for the combination of the allocation of multiple jobs to multiple hardware accelerators, the execution order of multiple jobs, and the execution timing of each of the multiple jobs. The user can select and set one combination from this list.

### (Configuration of the Design System)

First, the configuration of the design system according to this embodiment will be described. FIG. 1 is a block diagram of design system 1 according to the first embodiment of the present disclosure. As shown in FIG. 1, the design system 1 includes a graph editor unit 10, an optimization unit 20, and a result output unit 30.

The graph editor unit 10 is configured to create a pipeline graph as described above based on user input information. The user defines the processing content of each job in the pipeline graph, the processing time of each job, the type of hardware accelerator to be used for each job, and the precedence relationships of multiple jobs to the graph editor unit 10. The graph editor unit 10 creates a pipeline graph based on these definitions and settings and outputs the created pipeline graph to the optimization unit 20.

If the user has not input the processing time for each job, the graph editor unit 10 may estimate the processing time from the processing content or use prediction results from execution simulation.

Also, the design system 1 may not include the graph editor unit 10. In this case, the user performs the above work on an external device not shown, and the design system 1 may receive the pipeline graph from this external device.

Here, the pipeline graph that serves as input to the optimization unit 20 will be described. FIG. 2 is a diagram showing an example of a pipeline graph generated by the graph editor unit 10 shown in FIG. 1. In FIG. 2, each diamond shape is a node of the graph structure, indicating each job. Also, the precedence relationships between jobs are indicated by arrows.

In the example shown in FIG. 2, processing is performed as follows. Job1 is a camera job with a processing time of 30 milliseconds. When Job1 is completed, Job2 and Job4 become executable. Also, Job2 and Job4 are assigned to two channels ch0 and chl of hardware accelerator HWA1, and Job3 and Job5 are assigned to two channels ch0 and chl of hardware accelerator HWA2. When Job2 is completed, Job3 becomes executable, and when Job4 is completed, Job5 becomes executable. The processing time for Job2 and Job3 is 10+30=40 milliseconds, and the processing time for Job4 and Job5 is 20+20=40 milliseconds, so both paths have the same processing time. Finally, when both Job3 and Job5 are completed, Job6 becomes executable, and when Job6 is completed, the series of processes is completed. The processing time for the series of processes is 30+40+30=100 milliseconds.

Returning to the description of FIG. 1, the optimization unit 20 includes an HWA (hardware accelerator) allocation optimization unit 21 and a schedule optimization unit 22. The schedule optimization unit 22 performs optimization processing to reduce the total execution time of multiple jobs and is not specific to the present disclosure. Therefore, a detailed description of it is omitted. That is, the design system 1 may not include the schedule optimization unit 22. Below, in the description of the HWA allocation optimization unit 21, it may also be referred to as the optimization unit 20.

The HWA allocation optimization unit 21 of the optimization unit 20 receives the pipeline graph from the graph editor unit 10, job information related to multiple jobs included in the pipeline graph, hardware accelerator information related to multiple hardware accelerators, and optimization conditions. The optimization unit 20 is configured to create (determine) a list of candidates for the combination of the allocation of multiple jobs to multiple hardware accelerators, the execution order of multiple jobs, and the execution timing of each of the multiple jobs based on these inputs.

Here, the optimization conditions include at least an objective function indicating how to optimize the above combination and constraint conditions in the above combination. In this example, the objective function is a function to minimize the number of hardware accelerators to which one or more jobs are assigned in the pipeline graph.

Additionally, the constraints include three conditions: C1, C2, and C3. Constraint C1 is the condition that each job is assigned to only one hardware accelerator capable of executing that job. This is because jobs executed on a hardware accelerator can only be processed by a specific hardware accelerator, and within one cycle of a periodically executed video pipeline, a job must not be executed more than once.

Constraint C2 is the condition that the total execution time of jobs executed on a hardware accelerator is shorter than the frame rate of the input camera. Here, each hardware accelerator can only execute one job at a time, and if multiple jobs are assigned, the next job is executed after completing the current job. Therefore, if the total execution time of the assigned multiple jobs is longer than the camera's input interval (frame rate), there is a possibility of missing images input from the camera.

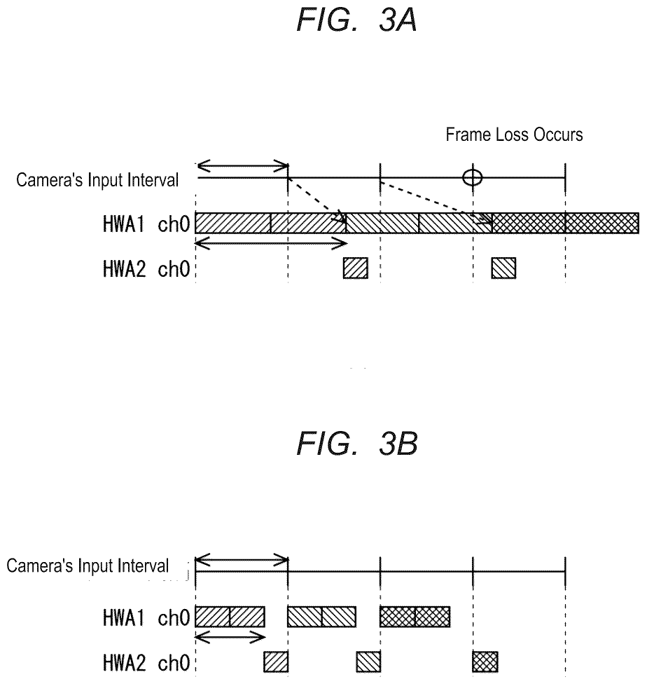

Here, FIGS. 3A and 3B show an example where frame loss occurs. FIGS. 3A and 3B are diagrams illustrating an example of hardware accelerator assignment where frame loss occurs. Here, it shows the case where a video pipeline is executed using channel ch0 of two hardware accelerators HWA1 and HWA2.

In FIG. 3A, the total execution time of two jobs executed on channel ch0 of hardware accelerator HWA1 is longer than the camera's input interval. As a result, hardware accelerator HWA1 misses the data input from the camera at the 4th frame (timing of the circle). On the other hand, in FIG. 3B, the total execution time of two jobs executed on channel ch0 of hardware accelerator HWA1 is shorter than the camera's input interval. Therefore, hardware accelerator HWA1 does not miss the data input from the camera.

Constraint C3 is the condition that when hardware accelerators are assigned to each job and the execution order and timing of jobs are determined, the time interval from the start timing of one or more jobs executed first to the end time of one or more jobs completed last is less than the delay upper limit. The delay upper limit is a value that can be set in advance by the user. This time interval (hereinafter also referred to as “delay”) is directly related to real-time performance, so it is necessary to set an upper limit for this delay from the safety and functional aspects of camera processing.

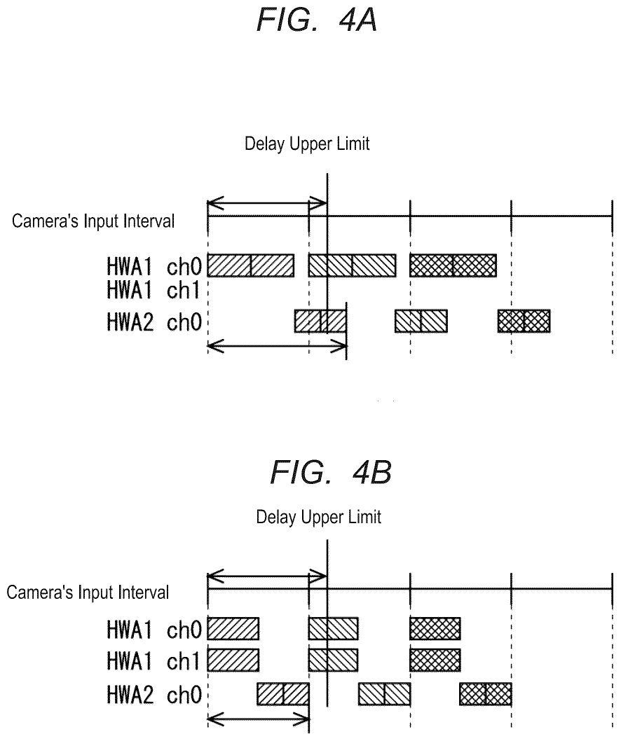

Here, FIGS. 4A and 4B show an example of delay change due to changes in hardware accelerator assignment methods. FIGS. 4A and 4B are diagrams illustrating an example of delay change due to hardware accelerator assignment methods. Here, it shows the case where a video pipeline is executed using two channels ch0, chl of hardware accelerator HWA1 and channel ch0 of hardware accelerator HWA2.

In FIG. 4A, multiple jobs are assigned so as not to use channel chl of hardware accelerator HWA1. There is a precedence constraint between the job assigned to channel ch0 of hardware accelerator HWA1 and the job assigned to channel ch0 of hardware accelerator HWA2. As a result, the delay increases, and the total execution time of all jobs exceeds the delay upper limit.

On the other hand, in the example of FIG. 4B, two jobs are distributed to channels ch0 and chl of hardware accelerator HWA1 on the condition that there is no precedence constraint on the two jobs assigned to channel ch0 of hardware accelerator HWA1 in FIG. 4A. As a result, the execution timing of the two jobs assigned to channel ch0 of hardware accelerator HWA1 becomes earlier. This allows the delay to be reduced (in this example, there is no delay), and it is found that all jobs can be executed within the delay upper limit.

The result output unit 30 is configured to receive the list of candidate combinations created by the optimization unit 20 from the optimization unit 20 and output this list of candidate combinations as a candidate list to the user. The result output unit 30 is also configured to output information on delay and utilization when executing each candidate combination in the candidate list to the user. The result output unit 30 may be a display device such as a liquid crystal display.

Additionally, the result output unit 30 is configured to accept the user's selection of one candidate from the list of candidate combinations output to the user. The user can confirm one or more candidates that satisfy the three constraints C1, C2, and C3, and select one candidate from them. The result output unit 30 may output information on the combination selected by the user to a video pipeline execution device or the like not shown.

### (Operation of the Design System)

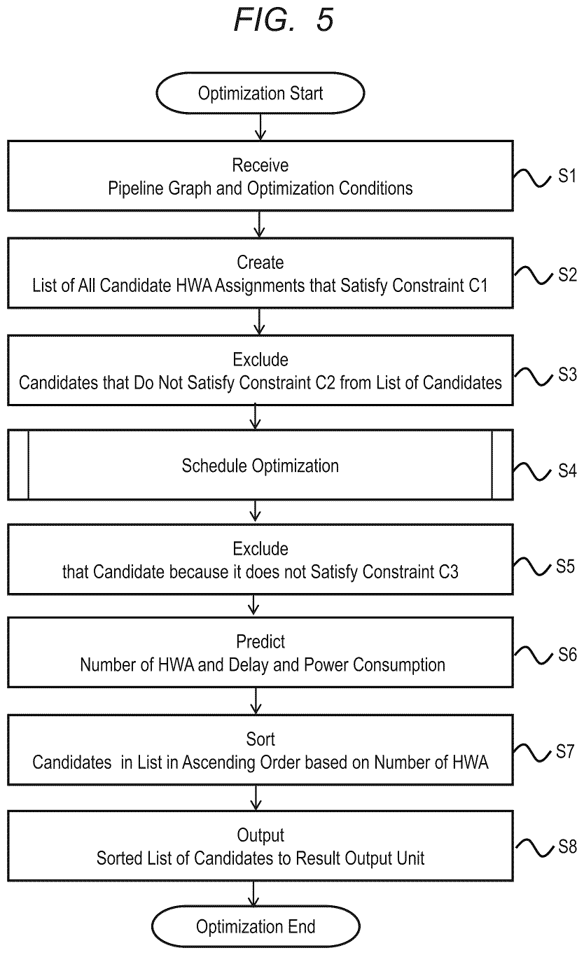

Next, the operation of the design system 1 according to this embodiment will be described. Here, after the graph editor unit 10 creates the pipeline graph shown in FIG. 2, the optimization process in which the optimization unit 20 optimizes the job execution schedule will be described. After this optimization process, the result output unit 30 will output (present) the candidate list to the user. FIG. 5 is a flowchart showing an example of the optimization process executed by the design system 1 shown in FIG. 1.

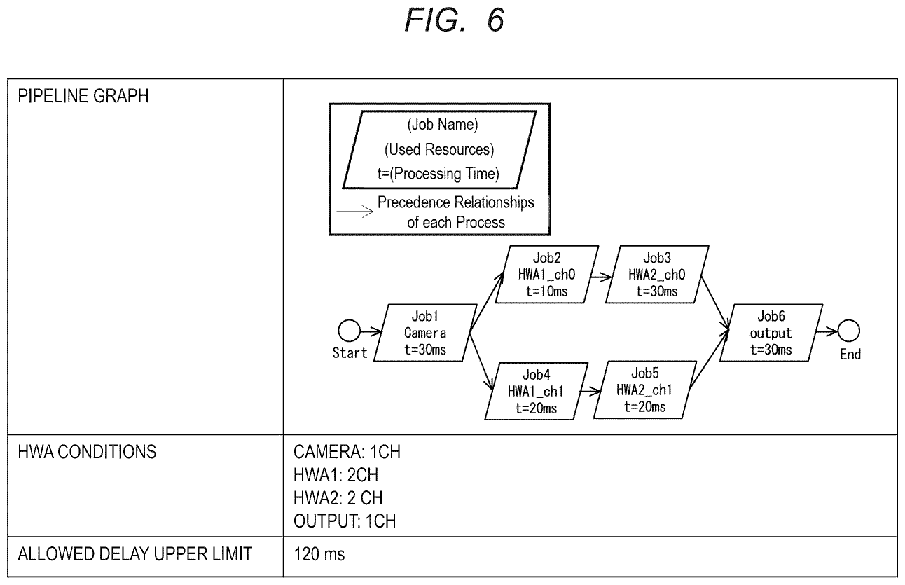

When the design system 1 starts the optimization process, the optimization unit 20 receives the pipeline graph created by the graph editor unit 10 and the optimization conditions (step S1). As mentioned above, the optimization conditions include conditions related to hardware accelerators (hereinafter also referred to as HWA conditions) and delay upper limits. The HWA conditions include the maximum number of hardware accelerators present in the execution environment, based on the device environment executing this video pipeline. The input parameters of step S1 are shown in FIG. 6. FIG. 6 is a diagram illustrating an example of parameters input to the optimization unit 20 shown in FIG. 1. In this example, the maximum number of hardware accelerators in the HWA conditions is two 4-channel units.

Based on the information received in step S1, the optimization unit 20 first creates a list of all candidate hardware accelerator assignments that satisfy condition 1 (step S2). The optimization unit 20 creates a list of all candidates when each job is assigned to the maximum number of hardware accelerators assignable to that job according to the HMA conditions. Note that similar hardware accelerators are not distinguished, and all jobs are assumed to be assigned to some hardware accelerator, but there may be hardware accelerators to which no job is assigned.

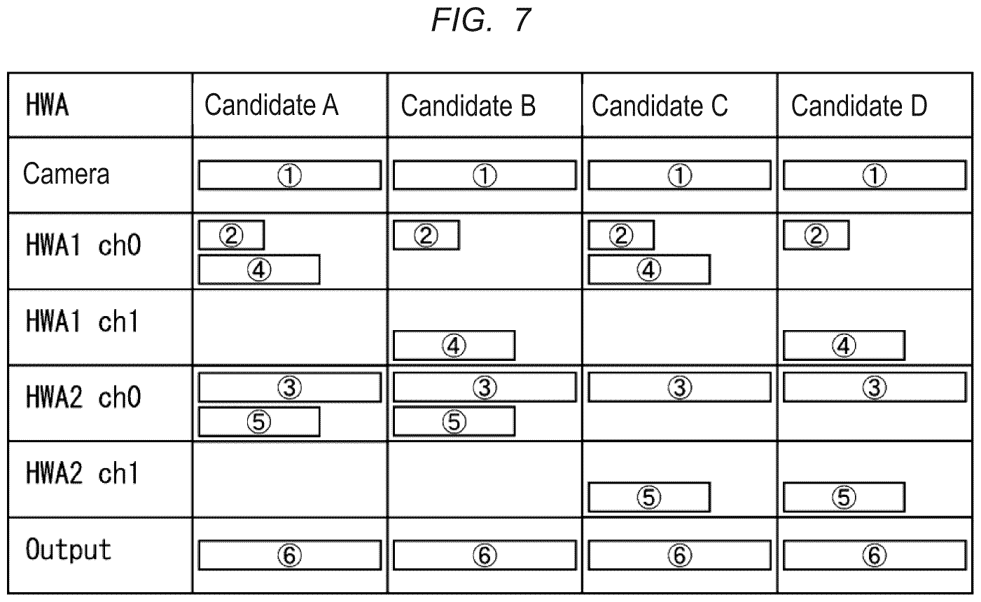

The list of candidates created in step S2 is shown in FIG. 7. FIG. 7 is a diagram illustrating an example of a list of candidates that satisfy constraint C1. Here, four candidates, A, B, C, and D, are listed. Note that as the number of hardware accelerators and jobs increases, the number of candidates also increases. Therefore, at this stage, it is not necessary to output the list of candidates.

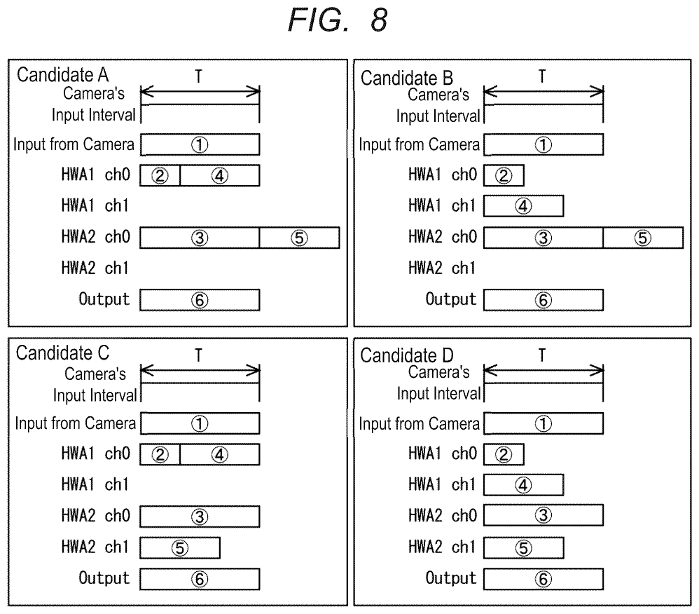

Next, optimization unit 20 excludes candidates that do not satisfy constraint C2 from the list of candidates created in step S2 (step S3). An example of checking constraint C2 is shown in FIG. 8. FIG. 8 is a diagram showing whether the list shown in FIG. 7 satisfies constraint C2. As can be seen from FIG. 8, candidates A and B do not satisfy constraint C2 because the total execution time of jobs on channel ch0 of hardware accelerator HWA2 is longer than the camera's input interval T. These candidates are excluded currently.

Next, the optimization unit 20 determines the execution order and timing of jobs with the minimum cycle length for each candidate remaining in step S3 using the method of non-patent document 1 (step S4).

Next, the optimization unit 20 calculates the delay for each candidate based on the execution order and timing of jobs determined in step S4. Then, the optimization unit 20 determines whether the delay in each candidate is greater than the delay upper limit. If there is a candidate with a delay greater than the delay upper limit, the optimization unit 20 excludes that candidate at this timing because it does not satisfy constraint C3 (step S5). In this example, no candidates are excluded in step S5.

Next, the optimization unit 20 determines the number of hardware accelerators to which one or more jobs are assigned for each candidate in the list remaining in step S5 and estimates and predicts the delay and power consumption (step S6). These data may be output to the user by the result output unit 30.

Next, the optimization unit 20 rearranges the candidates in the list in ascending order based on the number of hardware accelerators determined in step S6, that is, sorts the combination candidates by the number of hardware accelerators (step S7).

Finally, the optimization unit 20 outputs the sorted list of candidates to the result output unit 30 (step S8) and ends this optimization process.

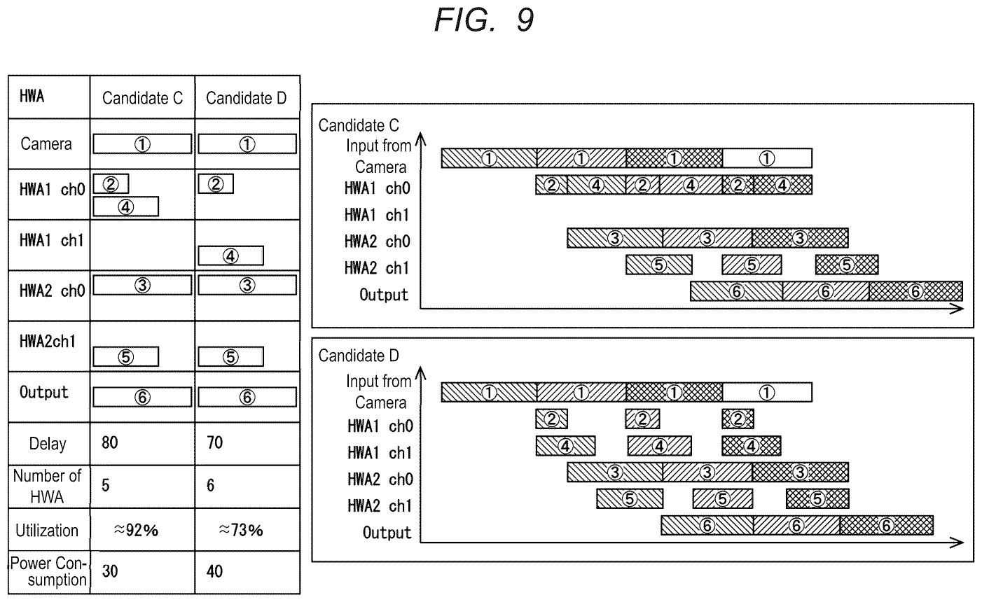

As a result of the above optimization process by the optimization unit 20, a list of candidates satisfying each constraint condition shown in FIG. 9 is obtained. FIG. 9 is a diagram showing the information output from the optimization unit 20 shown in FIG. 1. The result output unit 30 displays the information shown in FIG. 9 on a display device (not shown), thereby outputting (presenting) the list of combination candidates to the user.

As shown in FIG. 9, various parameters are also displayed to facilitate the user's decision-making when selecting one from the list of combination candidates. Various parameters may include, for example, delay (allowable time until all jobs are completed), hardware accelerator utilization rate, power consumption, and graphs showing the execution order and timing of each process.

Thus, in the design system 1 of this embodiment, the optimization unit 20 determines the allocation of multiple jobs to multiple hardware accelerators on behalf of the user. As a result, the user can easily obtain candidates for the allocation of hardware accelerators with the highest utilization rate by simply creating a pipeline graph. Moreover, the design system 1 of this embodiment may present a list of candidates weighted not only for utilization but also for other parameters such as delay. Furthermore, the design system 1 of this embodiment may be configured to allow the user to select parameters to be weighted. This allows the user to more easily select the optimal candidate that meets the system requirements.

As described above, the design system 1 of this embodiment is a design system for designing a video pipeline, comprising at least an optimization unit 20 and a result output unit 30. The optimization unit 20 is configured to create a list of candidates for the allocation of multiple jobs to multiple hardware accelerators, the execution order of multiple jobs, and the execution timing of each job based on the pipeline graph, job information, hardware accelerator information, and optimization conditions. The result output unit 30 is configured to output the list of combination candidates created by the optimization unit 20 to the user. By configuring the design system 1 in this manner, the user can check multiple schedule candidates that meet the optimization conditions and select the optimal candidate as desired. This increases the utilization rate of hardware accelerators during the execution of the video pipeline.

Here, the optimization conditions may include an objective function indicating how to optimize the combination and constraint conditions in the combination. The objective function may be a function for minimizing the number of hardware accelerators to which one or more of the multiple jobs are allocated. By configuring the design system 1 in this manner, there will be hardware accelerators that are not used during the execution of the video pipeline, and these unused hardware accelerators can be allocated to other applications.

In addition, the design method of this embodiment is a design method for designing a video pipeline. The design method accepts a pipeline graph and is configured to create a list of candidates for the allocation of multiple jobs to multiple hardware accelerators, the execution order of multiple jobs, and the execution timing of each job based on the pipeline graph, job information, hardware accelerator information, and optimization conditions, and to output the created list of combination candidates to the user. By configuring the design method in this manner, the same effects as the above-mentioned design system 1 can be achieved.

### Second Embodiment

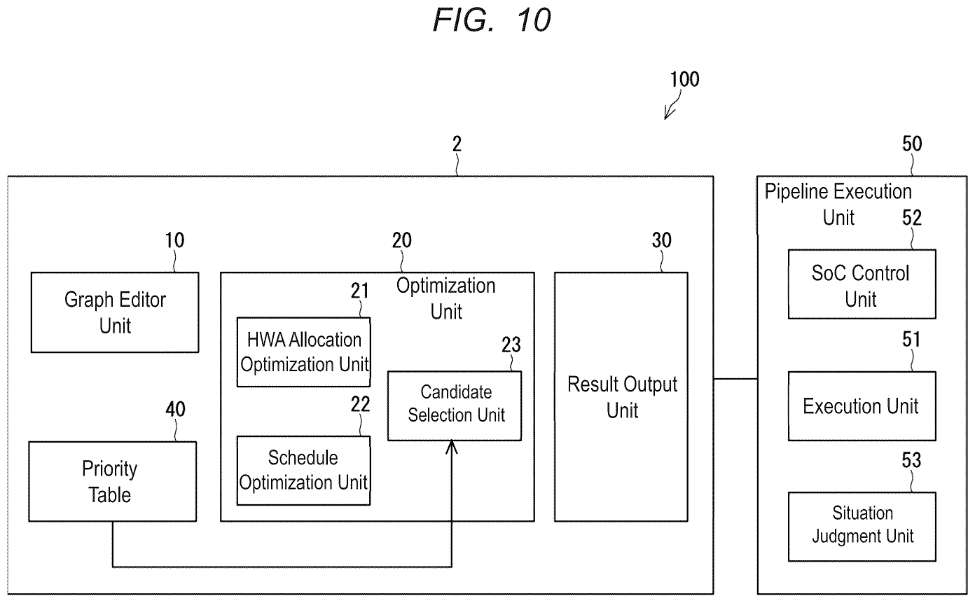

Next, with reference to FIGS. 10 to 14, a design/execution system according to the second embodiment of the present disclosure will be described. The design/execution system of this embodiment includes a design system similar to the design system 1 according to the first embodiment and a pipeline execution unit that serves as an execution system for executing the designed video pipeline. The design/execution system of this embodiment is mounted on a vehicle such as an automobile, for example.

### (Configuration of the Design/Execution System)

First, the configuration of the design/execution system according to this embodiment will be described. FIG. 10 is a block diagram of a design/execution system 100 according to the second embodiment of the present disclosure. As shown in FIG. 10, the design/execution system 100 includes a design system 2 and a pipeline execution unit 50.

The design system 2 according to this embodiment differs from the design system 1 according to the first embodiment in that the optimization unit 20 further includes a candidate selection unit 23 and a priority table 40 is provided. That is, the optimization unit 20 includes an HWA allocation optimization unit 21, a schedule optimization unit 22, and a candidate selection unit 23.

Like the first embodiment, the HWA allocation optimization unit 21 is configured to create (determine) a list of candidates for the allocation of multiple jobs to multiple hardware accelerators, the execution order of multiple jobs, and the execution timing of each of the multiple jobs based on the pipeline graph created by the graph editor unit 10 and user input information.

The HWA allocation optimization unit 21 outputs the created list of combination candidates to the candidate selection unit 23. The candidate selection unit 23 is configured to select one combination from the list of combination candidates based on the priority table 40. That is, the candidate selection unit 23 uses the list of combination candidates created by the HWA allocation optimization unit 21 and the priority table 40 to automatically rearrange the combination candidates based on the priority of each setting value or according to instructions from outside and selects the optimal combination candidate. The candidate selection unit 23 outputs the automatically rearranged list of combination candidates and the selected one combination to the result output unit 30.

The result output unit 30 is configured to output the one combination selected by the candidate selection unit 23 to the pipeline execution unit 50. The result output unit 30 is also configured to output the list of combination candidates automatically rearranged according to priority as a candidate list to the user and the pipeline execution unit 50. If the pipeline execution unit 50 selects and sets one combination from this candidate list, the result output unit 30 may not output this candidate list to the user.

The priority table 40 is created by the user and stored in a storage unit or the like (not shown). The priority table 40 holds priority setting values for multiple elements that can be set by the user. The priority table 40 created by the user may be output to the pipeline execution unit 50. In this case, the pipeline execution unit 50 may store the priority table 40 in a storage unit (not shown).

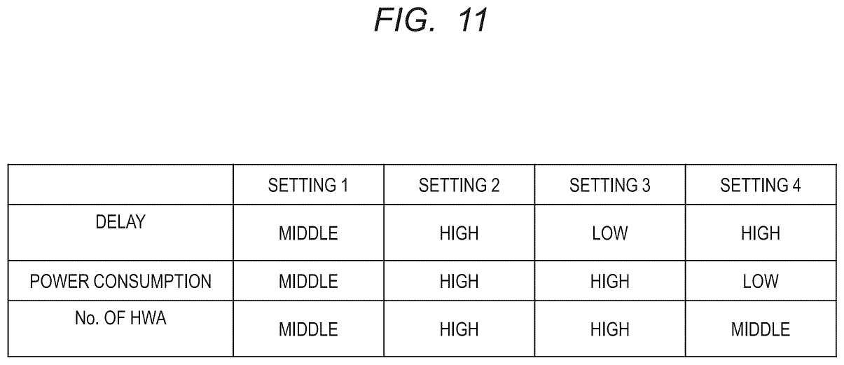

FIG. 11 is a diagram showing an example of priority table 40. As shown in FIG. 11, the priority table 40 includes at least one of the elements such as delay, power consumption, and the number of hardware accelerators described in the first embodiment. The priority table 40 may also include the total execution time when multiple jobs are executed as one of the multiple elements.

In terms of delay priority, a higher priority means lower delay. In terms of power consumption priority, a higher priority means reducing power consumption. The priority of the number of hardware accelerators means that the higher the priority, the fewer hardware accelerators are used.

Here, examples of internal and external conditions of the vehicle that affect priority will be described. One situation is that the remaining battery level of the vehicle becomes less than the standard. This state is one where the battery will soon run out and the vehicle will no longer be able to move. For example, an unintended stop due to battery depletion on a highway is dangerous, so it is necessary to keep the vehicle in a state where it can be moved until it can be evacuated to a safe place.

The second situation is detecting the approach of an object while the vehicle is in motion. This state is one where if the vehicle continues to drive, it may come into contact with the object. Depending on the accuracy of the sensor, it is assumed that the time until contact with the detected object is short. Therefore, applications that perform contact avoidance or detection with objects require higher real-time performance.

The parameters for setting the priority table 40 related to such vehicle conditions are stored in advance as setting condition parameters in a storage unit (not shown) of the pipeline execution unit 50. The setting condition parameters may include not only parameters related to the battery and the approach of objects but also many parameters related to the state of the vehicle and driving conditions.

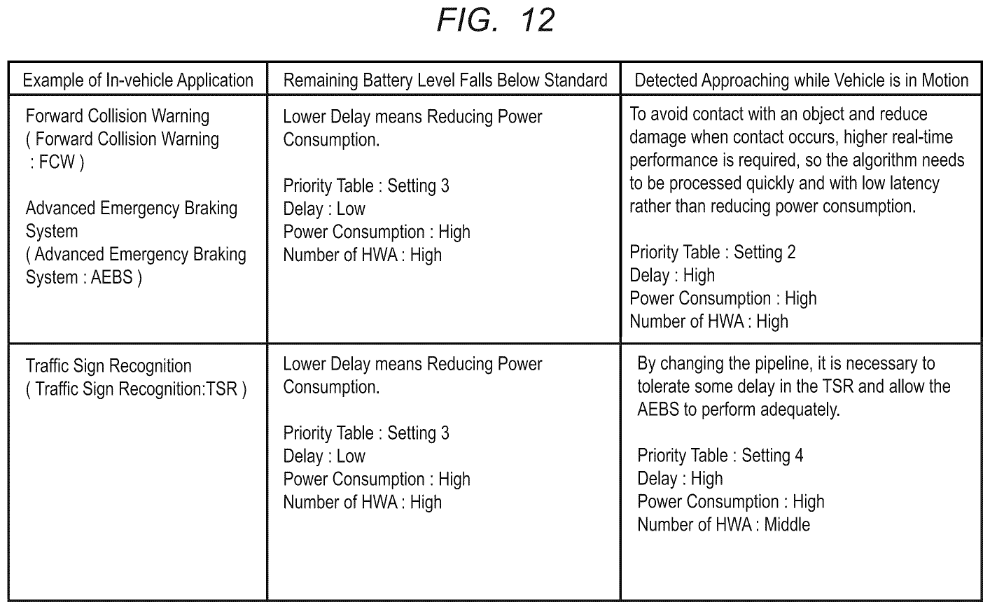

Next, an example of setting the priority table 40 in an in-vehicle application will be described. FIG. 12 is a table showing an example of the vehicle status and the priority table 40 settings in an in-vehicle application. In the example shown in FIG. 12, the in-vehicle application examples include forward collision warning and traffic sign recognition. It should be noted that during normal driving of the vehicle, setting 1 of the priority table 40 shown in FIG. 11 is set.

For example, if the remaining battery level falls below the standard, both the forward collision warning and traffic sign recognition can be set to setting 3 of the priority table 40 shown in FIG. 11. Also, if an object is detected approaching while the vehicle is in motion, the forward collision warning can be set to setting 2 of the priority table 40, and the traffic sign recognition can be set to setting 4 of the priority table 40. Such changes in settings are made in response to instructions from the pipeline execution unit 50. Alternatively, the pipeline execution unit 50 may make such setting changes based on the priority table 40 or candidate list stored in the storage unit, without going through the decision system 2.

As shown in FIG. 10, pipeline execution unit 50 includes an execution unit 51, an SoC control unit 52, and a situation judgment unit 53. The execution unit 51 is configured to execute the video pipeline based on the optimal combination output from design system 2. The SoC control unit 52 is configured to control a semiconductor device (not shown) mounted on the vehicle based on the video pipeline executed by the execution unit 51. The situation judgment unit 53 is configured to acquire information on the vehicle's condition and driving situation to determine the vehicle's status.

The situation judgment unit 53 is also configured to determine whether the current situation of the vehicle is one of the pre-set conditions (held in the priority table 40). If the situation judgment unit 53 determines that it is one of the set conditions, the execution unit 51 is configured to obtain a list of candidate combinations corresponding to the determined condition from optimization unit 20. The execution unit 51 is configured to select the optimal combination from the list of acquired candidate combinations according to the setting criteria corresponding to the determined condition in the priority table 40. The execution unit 51 is configured to compare the video pipeline corresponding to the optimal combination with the currently executing video pipeline, and if they do not match, change to and execute the video pipeline corresponding to the optimal combination.

When changing to and executing the video pipeline corresponding to the optimal combination, the execution unit 51 is configured to instruct the SoC control unit 52 to change the settings of the semiconductor device. The SoC control unit 52 may change the settings of the semiconductor device according to this instruction.

### (Operation of the Design/Execution System)

Next, the operation of the design/execution system 100 according to this embodiment will be described. Here, the optimization process executed by design system 2 and the state transition of the pipeline execution unit 50 in response to changes in the vehicle's condition will be described in detail.

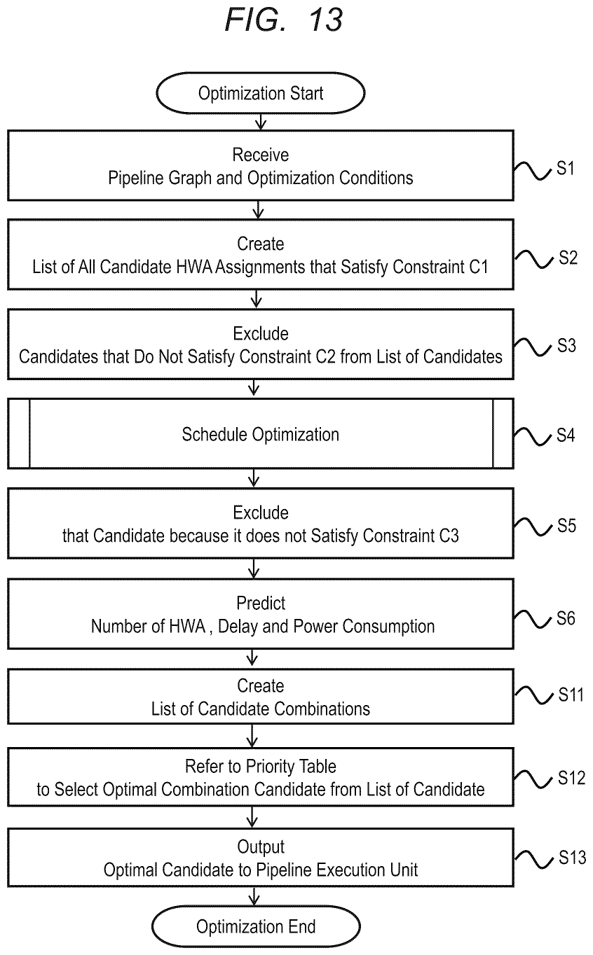

First, the optimization process executed by design system 2 will be described. FIG. 13 is a flowchart showing an example of the optimization process executed by the design system 2 shown in FIG. 10. In the flowchart shown in FIG. 13, the steps similar to those in the flowchart shown in FIG. 5 of the first embodiment are given the same step numbers, and their description is omitted.

In the process up to step S5, candidates that do not meet the constraints are excluded from the candidate combinations, and data such as delays are acquired (step S6), after which the optimization unit 20 creates a list of the remaining candidate combinations (step S11).

Then, the optimization unit 20 refers to the priority table 40 to select the optimal combination candidate for the current state of the vehicle from the list of candidate combinations (step S12), outputs the selected optimal combination candidate to the pipeline execution unit 50 (step S13) and ends this optimization process.

The optimization unit 20 may rearrange the candidate combinations in the list according to the priority table 40, create a list of the rearranged candidate combinations, output it to the pipeline execution unit 50, and end this optimization process.

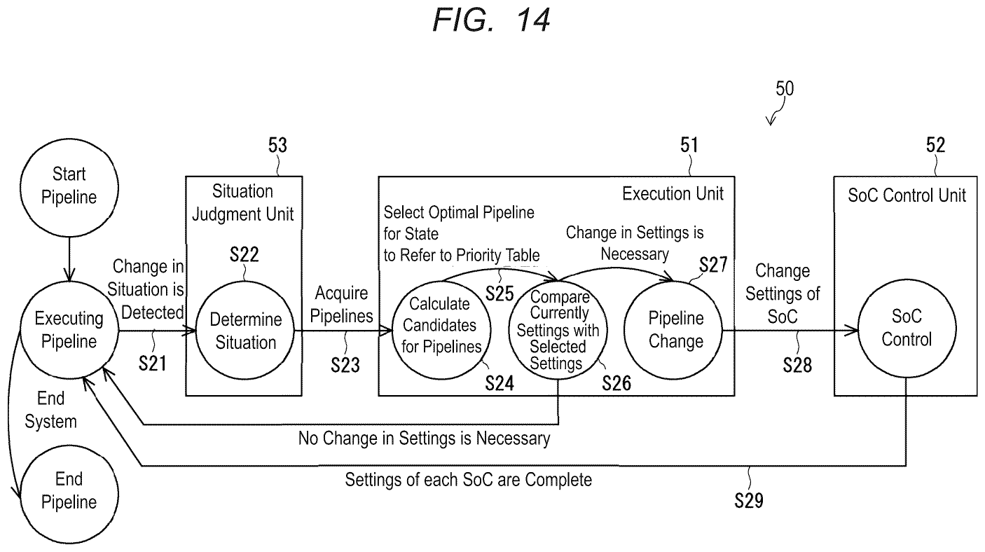

Next, the state transition of the pipeline execution unit 50 in response to changes in the vehicle's condition will be described. FIG. 14 is a diagram showing the state transition in the pipeline execution unit 50 shown in FIG. 10. When pipeline execution unit 50 starts executing the pipeline, the situation judgment unit 53 continues to monitor the detection results of various sensors provided in the vehicle during its execution.

When a change in the situation inside or outside the vehicle is detected (step S21), the situation judgment unit 53 determines the situation after the change (step S22) and outputs the result to the execution unit 51. The execution unit 51 acquires candidate combinations (i.e., candidates for multiple video pipelines) from the design system 2 according to the situation inside and outside the vehicle obtained as a result of the situation judgment (step S23).

Then, the execution unit 51 selects the video pipeline candidates that match the situation inside and outside the vehicle, calculates their applicability (e.g., a value indicating the degree to which they should be applied) (step S24), and selects the optimal video pipeline based on the calculation results and the priority table 40 (step S25).

Next, the execution unit 51 compares the currently set video pipeline with the selected video pipeline (step S26). If the video pipelines match, no change in settings is necessary, so the execution unit 51 ends this series of processes. On the other hand, if the video pipelines do not match, a change in settings is necessary, and the execution unit 51 prepares for the video pipeline change (step S27).

When preparing for the video pipeline change, the execution unit 51 instructs the SoC control unit 52 to change the settings of the SoC (not shown) (step S28). Upon receiving this instruction, the SoC control unit 52 changes the settings of each SoC, and once the settings of each SoC are complete, it notifies the execution unit 51 (step S29). Then, the execution unit 51 executes the newly set video pipeline.

As described above, design/execution system 100 of this embodiment is a design/execution system for designing and executing a video pipeline, and includes at least an optimization unit 20, a result output unit 30, and a pipeline execution unit 50. The optimization unit 20 is configured to create candidate combinations of assignments of multiple jobs to multiple hardware accelerators, execution order of multiple jobs, and execution timing of each job based on the pipeline graph, job information, hardware accelerator information, and optimization conditions. The optimization unit 20 is also configured to select one combination from the list of candidate combinations based on the priority table 40. The result output unit 30 is configured to output the one combination selected by the optimization unit 20 to the outside. The pipeline execution unit 50 is configured to execute the video pipeline based on the one combination output from the result output unit 30. By configuring the design/execution system 100 in this way, it is possible to eliminate user selection and select and execute a video pipeline corresponding to a more suitable combination.

In design/execution system 100 of this embodiment, one or more setting conditions may be set in the priority table 40, and the situation judgment unit 53 may determine whether the current situation of the vehicle is one of the pre-set conditions. Then, based on the judgment result of the situation judgment unit 53, the execution unit 51 may execute the video pipeline based on the setting suitable for the judgment result. In this way, by preparing multiple setting conditions in the priority table 40, it is possible to automatically output the appropriate combination according to the current situation without user intervention. As a result, the user only needs to create the pipeline graph and the priority table 40 and does not need to determine whether the video pipeline to be executed is optimal.

The design/execution method of this embodiment is a design/execution method for designing and executing a video pipeline. The design/execution method accepts a pipeline graph and, based on the pipeline graph, job information, hardware accelerator information, and optimization conditions, creates candidate combinations of assignments of multiple jobs to multiple hardware accelerators, execution order of multiple jobs, and execution timing of each job, selects one combination from the candidate combinations based on the priority table 40, outputs the selected one combination to the outside, and executes the video pipeline based on the output one combination. By configuring the design/execution method in this way, it is possible to achieve the same effects as the above-mentioned design/execution system 100.

Although the invention made by the inventor has been specifically described based on the embodiment, the present invention is not limited to the embodiment already described, and it is that various modifications can be made without departing from the gist thereof.

Furthermore, this disclosure can be realized by executing a computer program on a CPU, allowing part or all of the processing performed by the design system 1 or 2.

The aforementioned program, when loaded onto a computer, includes a set of instructions (or software code) to enable the computer to perform one or more functions described in the embodiment. The program may be stored on non-transitory computer-readable media or tangible storage media. By way of example and not limitation, the computer-readable media or tangible storage media may include RAM (Random-Access Memory), ROM (Read-Only Memory), flash memory, SSD (Solid-State Drive) or other memory technologies, CD-ROM, DVD (Digital Versatile Disc), Blu-ray (registered trademark) disc or other optical disc storage, magnetic cassette, magnetic tape, magnetic disk storage or other magnetic storage devices. The program may also be transmitted on a temporary computer-readable medium or communication medium. By way of example and not limitation, the temporary computer-readable medium or communication medium may include propagated signals in electrical, optical, acoustic, or other forms.

What is claimed is:

1. A design system for designing a video pipeline, comprising:
an optimization unit for creating a list of candidate combinations of assignments of a plurality of jobs to a plurality of hardware accelerators, execution orders of the plurality of jobs, and execution timings of each of the plurality of jobs, based on a pipeline graph, job information related to the plurality of jobs included in the pipeline graph, hardware accelerator information related to the plurality of hardware accelerators included in the pipeline graph, and optimization conditions; and
a result output unit for outputting the list of candidate combinations created by the optimization unit.

2. The design system according to claim 1,
wherein the optimization conditions include an objective function indicating how to optimize the combination and constraint conditions in the combination.

3. The design system according to claim 2,
wherein the objective function is a function for minimizing the number of hardware accelerators to which one or more of the plurality of jobs are assigned.

4. The design system according to claim 2,
wherein the video pipeline is used for image processing of a camera, and the constraint conditions include: each of the plurality of jobs is assigned to only one of the plurality of hardware accelerators capable of executing the corresponding job; the total execution time of one or more jobs executed on each of the plurality of hardware accelerators is shorter than the frame rate of the camera; and when the plurality of jobs are assigned to the plurality of hardware accelerators, and the execution order and execution timing of the plurality of jobs are determined, the time interval from the start time of one or more jobs executed first to the end time of one or more jobs executed last is smaller than a delay upper limit value.

5. The design system according to claim 4,
wherein the delay upper limit value can be preset by the user.

6. The design system according to claim 1 further comprises a graph editor unit for creating the pipeline graph based on user input information, and the graph editor unit outputs the created pipeline graph to the optimization unit.

7. The design system according to claim 1,
wherein the result output unit accepts selection from the list of candidate combinations output.

8. The design system according to claim 1,
wherein the optimization unit includes a hardware accelerators assignment optimization unit for optimizing the combination to minimize the number of hardware accelerators to which one or more of the plurality of jobs are assigned, and a schedule optimization unit for optimizing the combination to minimize the time to complete all executions of the plurality of jobs.

9. The design system according to claim 1,
wherein the hardware accelerator information includes the type of hardware accelerator and the number of hardware accelerators for each type.

10. A design/execution system for designing and executing a video pipeline, comprising:
an optimization unit for creating a list of candidate combinations of the assignment of a plurality of jobs to a plurality of hardware accelerators, execution orders of the plurality of jobs, and execution timings of each of the plurality of jobs, based on a pipeline graph, job information related to a plurality of jobs included in the pipeline graph, hardware accelerator information related to the plurality of hardware accelerators included in the pipeline graph, and optimization conditions, and selects one combination from the list of candidate combinations based on a priority table;
a result output unit for outputting the one combination selected by the optimization unit externally; and
a pipeline execution unit for executing the video pipeline based on the one combination output from the result output unit.

11. The design/execution system according to claim 10,
wherein the optimization unit rearranges the candidate combinations in the list of candidate combinations based on the priority table, and the result output unit outputs the rearranged list of candidate combinations to the user and the pipeline execution unit.

12. The design/execution system according to claim 10 is mounted on a vehicle, and the pipeline execution unit comprising:
an execution unit for executing the video pipeline based on the one combination;
a semiconductor device control unit for controlling a semiconductor device mounted on the vehicle based on the video pipeline executed by the execution unit; and
a situation determination unit for acquiring information on the state and driving conditions of the vehicle and determines the situation of the vehicle.

13. The design/execution system according to claim 12,
wherein the situation determination unit determines whether the current situation of the vehicle is one of the preset situations, and if the situation determination unit determines that the current situation of the vehicle is one of the preset situations, the execution unit acquires the list of candidate combinations corresponding to the determined preset situation from the optimization unit, selects the optimal combination from the acquired list of candidate combinations according to the setting criteria corresponding to the determined preset situation in the priority table, compares the video pipeline corresponding to the optimal combination with the video pipeline being executed, and if the video pipelines do not match, changes and executes the video pipeline corresponding to the optimal combination.

14. The design/execution system according to claim 13,
wherein the execution unit instructs the semiconductor device control unit to change the setting value of the semiconductor device when changing and executing the video pipeline corresponding to the optimal combination.

15. The design/execution system according to claim 14,
wherein the priority table holds priority settings for multiple elements that can be set by the user, and the multiple elements include at least one of the total execution times when executing the plurality of jobs in the pipeline graph, the number of hardware accelerators executing any of the plurality of jobs, or power consumption.

16. The design/execution system according to claim 10,
wherein the optimization conditions include an objective function indicating how to optimize the combination and constraint conditions in the combination.

17. The design/execution system according to claim 16,
wherein the objective function is a function for minimizing the number of hardware accelerators to which one or more of the plurality of jobs are assigned.

18. A design method for designing a video pipeline, comprising: receiving a pipeline graph, creating a list of candidate combinations of the assignment of the plurality of jobs to the plurality of hardware accelerators, the execution order of the plurality of jobs, and the execution timing of each of the plurality of jobs, based on the pipeline graph, job information related to a plurality of jobs included in the pipeline graph, hardware accelerator information related to a plurality of hardware accelerators included in the pipeline graph, and optimization conditions, and outputting the created list of candidate combinations to a user.
